(19) United States
(12) Patent Application Publication
(10) Pub. No.: US 2014/0280721 A1
(43) Pub. Date: Sep. 18, 2014

(54) COMPUTING DEVICE AND METHOD FOR TRANSMITTING DATA

(71) Applicant: CHIUN MAI COMMUNICATION SYSTEMS, INC., New Taipei (TW)

(72) Inventors: CHIA-JUNG HU, New Taipei (TW); KAI-HSI YANG, New Taipei (TW); CHUNG-WEI CHENG, New Taipei (TW); TAI-CHUAN CHEN, New Taipei (TW)

(73) Assignee: CHIUN MAI COMMUNICATION SYSTEMS, INC., New Taipei (TW)

(21) Appl. No.: 14/192,750

(22) Filed: Feb. 27, 2014

(30) Foreign Application Priority Data
Mar. 18, 2013 (TW) 102109405

(51) Int. Cl. H04L 29/08

(52) U.S. Cl. CPC H04L 67/10
USPC 709/217

(57) ABSTRACT

A computing device establishes communication between a first electronic device and a second electronic device for transmitting data. The computing device receives first register information from the first electronic device and second register information from the second electronic device and saves the first and second register information into a route list. The computing device sends the second register information in the route list to the first electronic device when receiving commands from the first electronic device, so that the first electronic device directly transfers data to the second electronic device according to the second register information.

### BACKGROUND

1. Technical Field

Embodiments of the present disclosure relate to data management technology, and particularly to a computing device and a method for transmitting data.

2. Description of Related Art

When an electronic device (e.g., a mobile phone) needs to transfer data (e.g., an e-mail) to a target electronic device, the electronic device needs to transfer the data to an third-party server first, then the data is transmitted from the third-party server to the target electronic device. Improved methods of direct transmitting data between two electronic devices are desirable.

### BRIEF DESCRIPTION OF THE DRAWINGS

FIG. 1 is a schematic block diagram of one embodiment of a computing device including a data transmitting system.

FIG. 2 is a schematic block diagram of one embodiment of the data transmitting system in FIG. 1.

FIG. 3 is a flowchart illustrating one embodiment of a data transmitting method.

FIG. 4 is a detailed description of step S20 in FIG. 3 of one embodiment for receiving first register information of a first electronic device.

FIG. 5 is a detailed description of step S30 in FIG. 3 of one embodiment for sending second register information of a second electronic device to the first electronic device.

FIG. 6 is a flowchart illustrating one embodiment of updated first register information method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

FIG. 1 is a block diagram of one embodiment of a computing device 1 including a data transmitting system 10. Depending on the embodiment, the data transmitting system 10 is implemented by the computing device 1. The computing device 1 is wirelessly connected to a first electronic device 2 and a second electronic device 3 via a network (e.g., the Internet or a local area network), as shown in FIG. 1. Both the first electronic device 2 and the second electronic device 3 provide an operation interface (not shown) for implementing one or more operations of the computing device 1. For example, the user inputs a username and a password in the operation interface provided by the first electronic device 2 and login in the data transmitting system 10 of the computing device 1. The data transmitting system 10 is used to establish a communication between the first electronic device 2 and the second electronic device 3, so that the first electronic device 2 can directly transfer data to the second electronic device 3. The computing device 1 may be, but is not limited to, a computer, a server, a portable electronic device, or any other electronic device. The first electronic device 2 and the second electronic device 3 may be, but are not limited to, mobile phones, tablet computers, personal digital assistants (PDAs), or any other portable mobile electronic devices.

FIG. 2 is a block diagram of one embodiment of the data transmitting system 10. In one embodiment, the data transmitting system 10 includes a generation module 110, a receiving module 120, and a sending module 130. The modules 110-130 may include computerized code in the form of one or more programs that are stored in a storage system 140 of the computing device 1. The computerized code includes instructions that are executed by the at least one processor 150 of the computing device 1 to provide functions for modules 110-130. The storage system 140 may be a memory chip, a hard disk drive, or a flash memory stick.

The generation module 110 generates a route list. The route list is used to record and store register information of a plurality of electronic devices, such as, first register information of the first electronic device 2 and second register information of the second electronic device 3. The first register information includes a telephone number and an Internet protocol (IP) address of the first electronic device 2. The second register information includes the telephone number and the IP address of the second electronic device 3.

The receiving module 120 receives the first register information from the first electronic device 2 and the second register information from the second electronic device 3, and inserts/records the first and second register information into the route list, then saves the route list after edition. A detailed description of how to receive the first register information is described in FIG. 4.

The sending module 130 sends the second register information in the route list to the first electronic device 2 when receiving commands from the first electronic device 2. In one embodiment, the commands are sent from the first electronic device 2 to the computing device 1 and request to obtain the second register information from the computing device 1. The commands may include the telephone number of the second electronic device 3. The first electronic device 2 can directly transfer data to the second electronic device 3 when the first electronic device 2 receives the second register information. A detailed description of a procedure of transmitting the second register information to the first electronic device 2 is described in FIG. 5.

The first electronic device 2 directly transfers data to the second electronic device 3. In one embodiment, the second register information includes the IP address of the second electronic device 3, and the first electronic device 2 can transfer data to the second electronic device 3 according to the IP address of the second electronic device 3.

FIG. 3 is a flowchart of one embodiment of a data transmitting method. Depending on the embodiment, additional steps may be added, others deleted, and the ordering of the steps may be changed.

In step S10, the generation module 110 generates a route list. As mentioned above, the first register information and the second register information are stored into the route list. A telephone number (e.g., 666666) and an Internet protocol (IP) address (e.g., 10.10.10.10) of the first electronic device 2 are integrated into the first register information. The telephone number (e.g., 888888) and the IP address (e.g., 20.20.20.20) of the second electronic device 3 are integrated into the second register information.

In step S20, the receiving module 120 receives the first register information from the first electronic device 2 and the second register information from the second electronic device 3, and inserts/records the first and second register information into the route list, then saves the route list after edition. A detailed description of how to receive the first register information is described in FIG. 4.

In step S30, the sending module 130 sends the second register information in the route list to the first electronic device 2 when receiving commands from the first electronic device 2. As mentioned above, the commands may include the telephone number of the second electronic device 3. For example, the commands include telephone number “888888.” The computing device 1 can search the second register information according to the telephone number of the second electronic device 3. A detailed description of procedure of transmitting the second register information to the first electronic device 2 is described in FIG. 5.

In step S40, the first electronic device 2 directly transfers data to the second electronic device 3. In one embodiment, the second register information includes the IP address of the second electronic device 3, and the first electronic device 2 can transfer data to the second electronic device 3 according to the IP address (e.g., 20.20.20.20).

FIG. 4 is a detailed description of step S20 in FIG. 3 of one embodiment for receiving first register information of the first electronic device.

In step S210, the receiving module 120 receives a connection request from the first electronic device 2. The connection request is used to request a communication with the computing device 1. The connection request includes the IP address of the first electronic device 2. The computing device 2 establishes the communication with the first electronic device 2 according to the IP address of the first electronic device 2.

In step S220, the receiving module 120 determines whether the first electronic device 2 has been registered. In one embodiment, the first electronic device 2 has been registered upon the condition that the route list includes the first register information. If the route list does not include the first register information, the receiving module 120 determines that the first electronic device 2 has not been registered, the procedure goes to step S230. Otherwise, if the route list includes the first register information, the receiving module 120 determines that the first electronic device 2 has been registered, the procedure ends.

In step S230, the receiving module 120 receives the first register information from the first electronic device 2, and inserts/records the first register information into the route list, then saves the route list after edition.

In step S240, the receiving module 120 notifies the first electronic device to generate a related list. In one embodiment, the related list includes the telephone number and an international mobile subscriber identity (IMSI) code of the first electronic device 3. The related list is stored in the first electronic device 2 after the related list is generated. the second register information also can be updated according to the flowchart of FIG. 6

Furthermore, the second register information of the second electronic device also can be received according to the flowchart of FIG. 4. In such a situation, the first electronic device 2 is replaced by the second electronic device 3, the first register information is replaced by the second register information.

FIG. 5 is a detailed description of step S30 in FIG. 3 of one embodiment for sending second register information of the second electronic device to the first electronic device.

In step S400, the receiving module 120 receives the connection request from the first electronic device 2.

In step S410, the receiving module 120 determines if the telephone number of the first electronic device 2 is changed. In one embodiment, the first electronic device 2 includes a subscriber identity module (SIM) card, the SIM card includes the telephone number of the first electronic device 2 and an IMSI code of the first electronic device 2. The receiving module 120 obtains the telephone number and the IMSI code from the SIM card of the first electronic device 2. The receiving module 120 compares the IMSI code in the SIM with the IMSI code in the related list stored in the first electronic device 2. If the IMSI code in the SIM card matches the IMSI code in the related list, then the receiving module 120 determines that the telephone number of the first electronic device 2 is not changed, the procedure goes to step S420. Otherwise, if the IMSI code in the SIM card does not match the IMSI code in the related list, then the receiving module 120 determines that the telephone number of the first electronic device 2 is changed, the procedure ends.

In step S420, the receiving module 120 receives the telephone number of the second electronic device 3 from the first electronic device 1. In one embodiment, a user inputs the telephone number of the second electronic device 3 in an interface (e.g., a virtual keyboard displayed in a touch screen of the first electronic device 2) of the first electronic device 2. The telephone number of the second electronic device 3 inputted by the user is sent to the computing device 1 by the first electronic device 2.

In step S430, the receiving module 120 determines if the telephone number of the second electronic device 3 is recorded in the route list. In one embodiment, the receiving module 120 uses the telephone number of the second electronic device 3 as a keyword to search the route list. If the telephone number of the second electronic device 3 is recorded in the route list, the procedure goes to step S440. Otherwise, if the telephone number of the second electronic device 3 is not recorded in the route list, the procedure ends.

In step S440, the receiving module 120 obtains the IP address of the second electronic device 3 from the route list according to the telephone number of the second electronic device 3.

FIG. 6 is a flowchart illustrating one embodiment of updated first register information method.

In step S510, the computing device 1 receives a updating request from the first electronic device 2. Before sending the updating request to the computing device 1, the first electronic device 2 checks whether the first register information of the first electronic device 2 is changed. The first electronic device 2 sends the updating request to the computing device 1 upon the condition that the first register information of the first electronic device 2 is changed.

In step S520, the computing device 1 determines if the telephone number of the first electronic device 2 is changed. The computing device 1 obtains the IMSI code from the SIM card of the first electronic device 2. The computing device 1 compares the IMSI code in the SIM with the IMSI code in the related list stored in the first electronic device 2. If the IMSI code in the SIM card matches the IMSI code in the related list, then the computing device 1 determines that the telephone number of the first electronic device 2 does not be changed, the procedure ends. Otherwise, if the IMSI code in the SIM card matches the IMSI code in the related list, then the computing device 1 determines that the telephone number of the first electronic device 2 is changed, the procedure goes to step S530.

In step S530, the computing device 1 receives updated first register information from the first electronic device 2.

In step S540, the computing device 1 updates the route list according to the updated first register information. In one embodiment, the computing device 1 replaces the original first register information in the route list using the updated first register information.

Furthermore, the second register information also can be updated according to the flowchart of FIG. 6. In such a situation, the first electronic device 2 is replaced by the second electronic device 3, the first register information is replaced by the second register information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device in communication with a first electronic device and a second electronic device, comprising:
at least one processor; and
a storage system that stores one or more programs and a route list, when executed by the at least one processor, cause the at least one processor to:
receive first register information from the first electronic device and second register information from the second electronic device, and insert/record the first register information into the route list; and
send the second register information in the route list to the first electronic device when receiving commands from the first electronic device, wherein the first electronic device directly transmits data to the second electronic device according to the second register information.

2. The computing device of claim 1, wherein the first register information comprises a telephone number and an Internet protocol (IP) address of the first electronic device, and the second register information comprises a telephone number and an IP address of the second electronic device.

3. The computing device of claim 1, wherein the at least one processor that receives first register information from the first electronic device further to:
receiving a connection request from the first electronic device;
determining whether the first electronic device has been registered;
receiving the first register information from the first electronic device and storing the first register information into the route list, under the condition that the first electronic device has not been registered; and
notifying the first electronic device to generate a related list.

4. The computing device of claim 3, wherein the connection request comprises an IP address of the first electronic device.

5. The computing device of claim 3, wherein the first electronic device is determined to be registered upon the condition that the route list comprises the first register information.

6. The computing device of claim 3, wherein the related list comprises a telephone number and an international mobile subscriber identity (IMSI) code of the first electronic device.

7. The computing device of claim 2, wherein the at least one processor that sends the second register information in the route list to the first electronic device further to:
receiving a connection request from the first electronic device;
determining whether the telephone number of the first electronic device is changed according to the first register information in the route list;
receiving the telephone number of the second electronic device from the first electronic device, under the condition that the telephone number of the first electronic device is not changed;
determining whether the telephone number of the second electronic device is recorded in the route list; and
obtaining the IP address of the second electronic device from the route list according to the telephone number of the second electronic device, under the condition that the telephone number of the second electronic device is recorded in the route list.

8. The computing device of claim 7, wherein the telephone number of the first electronic device is changed upon the condition that an IMSI code in a subscriber identity module (SIM) card of the first electronic device does not matches the IMSI code in a related list of the first electronic device.

9. The computing device of claim 1, wherein the at least one processor further to:
receive a updating request from the first electronic device by the computing device;
determine whether the telephone number of the first electronic device is changed by the computing device;
receive updated first register information from the first electronic device by the computing device; and
update the route list according to the updating first register information by the computing device.

10. The computing device of claim 9, wherein the first electronic device sends an updating request to the computing device upon the condition that the first register information of the first electronic device is changed.

11. A computer-based data transmitting method using a computing device, the method comprising:
receiving first register information from the first electronic device and second register information from the second electronic device, and inserting/recording the first register information into a route list stored in the computing device; and
sending the second register information in the route list to the first electronic device when receiving commands from the first electronic device, and the first electronic device directly transmitting data to the second electronic device.

12. The method of claim 11, wherein the first register information comprises a telephone number and an Internet protocol (IP) address of the first electronic device, and the second register information comprises a telephone number and an IP address of the second electronic device.

13. The method of claim 11, wherein the step of receiving first register information from the first electronic device comprises:
receiving a connection request from the first electronic device;
determining whether the first electronic device has been registered;
receiving the first register information from the first electronic device and storing the first register information into the route list, under the condition that the first electronic device has not been registered; and
notifying the first electronic device to generate a related list.

14. The method of claim 13, wherein the connection request comprises an IP address of the first electronic device.

15. The method of claim 13, wherein the first electronic device is determined to be registered upon the condition that the route list comprises the first register information.

16. The method of claim 13, wherein the related list comprises a telephone number and an IMSI code of the first electronic device.

17. The method of claim 12, wherein the step of sending the second register information in the route list to the first electronic device comprises:
receiving a connection request from the first electronic device;
determining whether the telephone number of the first electronic device is changed according to the first register information in the route list;
receiving the telephone number of the second electronic device from the first electronic device, under the condition that the telephone number of the first electronic device is not changed;
determining whether the telephone number of the second electronic device is recorded in the route list; and
obtaining the IP address of the second electronic device from the route list according to the telephone number of the second electronic device, under the condition that the telephone number of the second electronic device is recorded in the route list.

18. The method of claim 17, wherein the telephone number of the first electronic device is changed upon the condition that an IMSI code in a SIM card of the first electronic device does not matches the IMSI code in a related list of the first electronic device.

19. The method of claim 11, wherein the data transferring method further comprises:
receiving a updating request from the first electronic device by the computing device;
determining whether the telephone number of the first electronic device is changed by the computing device;
receiving updated first register information from the first electronic device by the computing device; and
updating the route list according to the updating first register information by the computing device.

20. The method of claim 19, wherein the first electronic device sends an updating request to the computing device upon the condition that the first register information of the first electronic device is changed.
